(19) United States
(12) Patent Application Publication
(10) Pub. No.: US 2019/0058498 A1
(43) Pub. Date: Feb. 21, 2019

(54) A BROADBAND SUPERHETERODYNE RADIO RECEIVER

(71) Applicants: ISTANBUL SEHIR UNIVERSITESI, Sisli/Istanbul (TR); INNOVAT BILGISAYAR VE ELEKTRONIK SANAYIVE TICARET LIMITED SIRKETI, Kadikoy/Istanbul (TR)

(72) Inventors: Hakan DOGAN, Altunizade, Istanbul (TR); Mehmet Tamer OZGUN, Altunizade, Istanbul (TR)

(21) Appl. No.: 16/078,851

(22) PCT Filed: Feb. 22, 2017
(86) PCT No.: PCT/TR2017/050070

§ 371 Date: Aug. 22, 2018

(30) Foreign Application Priority Data
Feb. 23, 2016 (TR) 2016/02285

(51) Int. Cl. H04B 1/10; H04B 1/26; H04B 15/00

(52) U.S. Cl. CPC H04B 1/1027; H04B 15/005; H04B 1/26

(57) ABSTRACT

The present invention is a superheterodyne radio receiver comprising a radio frequency front end (2) which processes a radio signal, received by means of an antenna (1) and including a desired signal, at the original frequency of the radio signal and which transmits said radio signal to a stirrer (3) in order to be converted into digital signal. Accordingly, the present invention is characterized in that said radio frequency front end (2) comprises a first amplifier (211) and a first LC filter (221) connected to said first amplifier (211), said radio frequency front end (2) comprises a second amplifier (212) connected serially to said first amplifier (211) in order to raise the radio signal, and further comprises a second LC filter (222) connected to said second amplifier (212) in order to filter the radio signal in a stepped manner.

### TECHNICAL FIELD

The present invention relates to superheterodyne radio receivers comprising a radio frequency front end which processes a radio signal, received by means of an antenna, at the original frequency of the radio signal and which transmits said radio signal to a stirrer in order to be converted into digital signal.

### PRIOR ART

Superheterodyne radio receivers are used in converting radio signals into digital form. The signal, received from an antenna, is passed through filter at a radio frequency front end and it is partially purified from the signals at the undesired frequency and raised. Afterwards, it is placed to the intermediate frequency by means of a stirrer and it is passed through filtering and raising processes and it is converted into digital signal.

The range, between the power of the received signal and the maximum power of the undesired signal which can be prevented by the radio receiver, is defined as the dynamic range. Superheterodyne radio receivers need sharp filters at the radio frequency front end in order to have wide dynamic range, in order words, in order to separate a signal received from a far source with low decibel and a high power signal which is close to said signal. Particularly when the signal, which is desired to be received, has low frequency, these sharp filters reach big dimensions. Thus, it is difficult to be used in radio receivers like handheld radio.

In the present art, in order to provide wide dynamic range, high Q adjustable RF filters are used and discrete amplifiers which follow the filters are used. These lead to big dimensioned radios. Handheld radio receivers are needed having wide dynamic range and at the same time, which can receive signals in wide frequency range.

As a result, because of all of the abovementioned problems, an improvement is required in the related technical field.

### BRIEF DESCRIPTION OF THE INVENTION

The present invention relates to a radio receiver, for eliminating the above mentioned disadvantages and for bringing new advantages to the related technical field.

The main object of the present invention is to provide a radio receiver whose dynamic range is increased.

The main object of the present invention is to provide a radio receiver having increased dynamic range including VHF and UHF frequency bands.

Another object of the present invention is to provide a radio receiver which can operate in the frequency range whose width is increased.

Another object of the present invention is to provide a radio receiver which is in manually portable dimensions and which can operate at wide frequency range.

Another object of the present invention is to provide a radio receiver which is in manually portable dimensions and which has increased dynamic range.

Another object of the present invention is to provide a radio receiver whose integration into chip is increased.

In order to realize all of the abovementioned objects and the objects which are to be deducted from the detailed description below, the present invention is a radio receiver comprising a radio frequency front end which processes a radio signal, received by means of an antenna and including a desired signal, at the original frequency of the radio signal and which transmits said radio signal to a stirrer in order to be converted into digital signal. Accordingly, the improvement of the present invention is that said radio frequency front end comprises a first amplifier and a first adjustable LC filter connected to said first amplifier, said radio frequency front end comprises a second amplifier connected serially to said first amplifier in order to raise the radio signal in a stepped manner, and further comprises a second LC filter connected to said second amplifier in order to filter the radio signal in a stepped manner. Thus, by means of the pluralities of amplifiers, the radio signal can be raised and filtered in a stepped manner and the high powered undesired signals which are close to the desired signal are less raised or kept fixed in a stepped manner when compared with the desired signal. Thus, when the desired signal, which reaches a power which is close to the undesired signals, is reduced to the basic band, it can be filtered and purified from the undesired signals. As pluralities of filters and pluralities of amplifiers are used step by step, filtering with smaller dimension can be realized which is substantially close to the filtering realized by the sharp filters having big dimensions. A radio can be obtained with small dimensions and with high dynamic range.

In a preferred embodiment of the present invention, said first amplifier has an inlet which has substantially a broadband range and the output thereof is divided into pluralities of band ranges.

In another preferred embodiment of the present invention, in order to raise the radio signal in a stepped manner, a third amplifier is provided which is connected to said second amplifier in a serial manner and a third LC filter is provided which is connected to said third amplifier in order to filter the radio signal in a stepped manner.

In another preferred embodiment of the present invention, said radio frequency front end comprises a first adjustable dampener connected serially to the second amplifier and the third amplifier and a second dampener connected serially to the third amplifier in order to dampen the power of the radio signal in a stepped manner for preventing saturation of the receiver, when the side channel undesired signals, which cannot be substantially filtered by the first and second selective amplifiers and which are in a frequency range which is very close to the desired signal, are at a substantially high power. Thus, when the side channel radio signals, which cannot be substantially filtered, are high, the radio signal is dampened in a stepped manner, and the overloading of the receiver is prevented.

In another preferred embodiment of the present invention, said first dampener is provided between the second amplifier and the third amplifier.

In another preferred embodiment of the present invention, said second dampener is provided at the output of the third amplifier.

In another preferred embodiment of the present invention, a digital rear end is provided which is connected to the radio frequency front end,

said digital rear end is configured in a manner changing the inner configuration of said first LC filter and said second LC filter and in a manner changing the band range which passes signal. Thus, the signals, provided in the widened frequency range, can be filtered by means of LC filters whose filtering range can be changed. This allows the radio receiver to operate in broad frequency band.

In another preferred embodiment of the present invention, a digital rear end is provided which is connected to the radio frequency front end,

said digital rear end is configured in a manner changing the inner configuration of said first LC filter and said second LC filter and said third LC filter and in a manner adjusting the band range which passes signal.

In another preferred embodiment of the present invention, said digital rear end is configured in a manner increasing the gain values of the first amplifier and the second amplifier when the power of the desired signal is substantially low.

In another preferred embodiment of the present invention, said digital rear end is configured in a manner increasing the gain values of the first amplifier and the second amplifier when the power of the desired signal is substantially low,

said digital rear end is configured in a manner reducing the dampening coefficients of the first dampener and the second dampener. Said digital rear end is configured in a manner reducing the gain values of the first amplifier and the second amplifier when the power of the desired signal is substantially high.

In another preferred embodiment of the present invention, said digital rear end is configured in a manner reducing the gain values of the first amplifier and the second amplifier when the power of the desired signal is substantially high,

said digital rear end is configured in a manner increasing the dampening coefficients of the first dampener and the second dampener. Thus, the maximum signal level is fixed at every point of the receiver in accordance with signal envelope measurements to be made at the ends of determined amplifiers, and the noise and linearity performances of the receiver will be simultaneously optimized.

In another preferred embodiment of the present invention, said radio frequency front end comprises pluralities of LC filters.

In another preferred embodiment of the present invention, said radio frequency front end comprises pluralities of amplifiers.

Moreover, the present invention is a signal processing method at a radio frequency in order to process a radio signal, received by means of an antenna and including a desired signal, at the original frequency of the radio signal and transmitting said radio signal to a stirrer in order to be converted into digital signal. Accordingly, the improvement of the subject matter method is that the radio signal is raised and filtered by means of a first amplifier and a first LC filter adjusted in a substantially close manner to the center frequency of the desired signal,

the radio signal is raised and filtered by means of a second amplifier and a second LC filter adjusted in a substantially close manner to the center frequency of the desired signal.

In another preferred embodiment of the present invention, the radio signal is filtered and raised in a stepped manner by means of a third amplifier and by means of a third LC filter connected to said second amplifier.

In another preferred embodiment of the present invention, the radio signal is dampened in a stepped manner by means of a first dampener and a second dampener.

In another preferred embodiment of the present invention, the first LC filter, the second LC filter and the third LC filter change the inner configuration and change the band range which pass signal in accordance with the desired signal frequency.

### BRIEF DESCRIPTION OF THE FIGURES

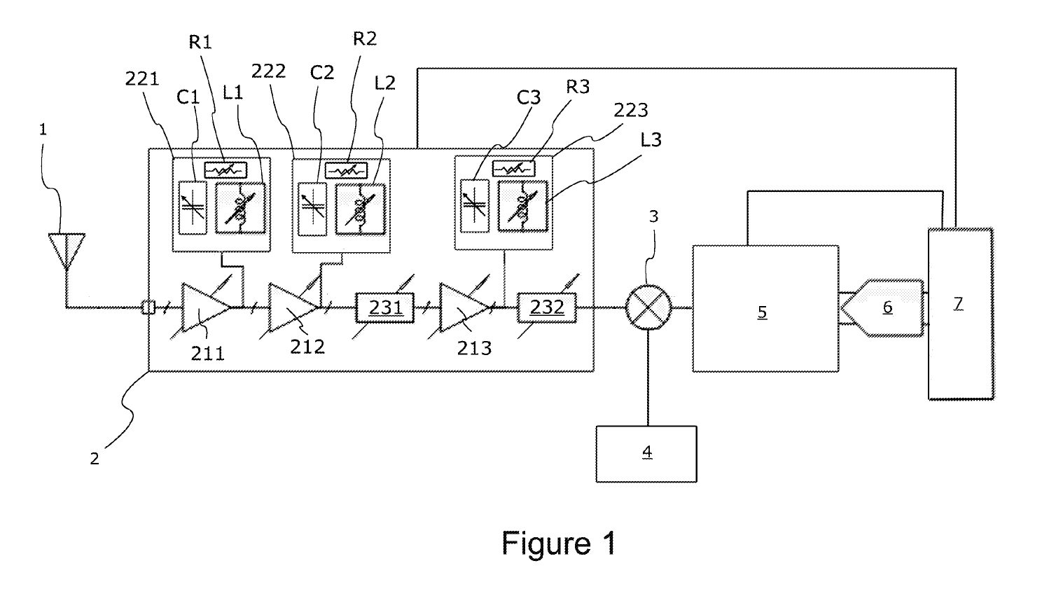

In FIG. 1, a representative view of the radio receiver is given.

### REFERENCE NUMBERS

1 Antenna
2 Radio frequency front end
211 First amplifier
212 Second amplifier
213 Third amplifier
221 First LC filter
L1 First inductor bank
C1 First capacitor bank
R1 First variable resistor
222 Second LC filter
L2 Second inductor bank
C2 Second capacitor bank
R2 Second variable resistor
223 Third LC filter
L3 Third inductor bank
C3 Third capacitor bank
R3 Third variable resistor
231 First dampener
232 Second dampener
3 Stirrer
4 Local oscillator
5 Intermediate frequency end
6 Converter from analog to digital
7 Digital rear end

### DETAILED DESCRIPTION OF THE INVENTION

In this detailed description, the subject matter radio receiver is explained with references to examples without forming any restrictive effect only in order to make the subject more understandable.

In this detailed description, the signals received by the radio receiver have been named as radio signals. The signal, which is desired to be focused, is named as the desired signal. The signals except the desired signal are named as undesired signals. The undesired signals, which have frequency which is substantially close to the frequency of the desired signal, are defined as close undesired signals, and the undesired signals, which have frequency which is substantially far from the frequency of the desired signal, are defined as far undesired signals. The signal, whose radio signal is desired, includes the close undesired signal and the far undesired signal. For instance, if a signal, having 100 MHz center frequency, is a desired signal, a signal, having 120 MHz center frequency, is a close undesired signal, and a signal, having 200 MHz center frequency, is a far undesired signal.

The present invention is a superheterodyne radio receiver. The radio receiver in general realizes processes on the radio signal received by means of an antenna (1) and converts it into digital signal. The present invention comprises a radio frequency front end (2) connected to said antenna (1) and where processes are realized on the original radio frequency. The signal having original radio frequency processed at the radio frequency front end (2) is transmitted to a stirrer (3) connected to the radio frequency front end (2). A local oscillator (4) is connected to said stirrer (3).

The signal, coming from said local oscillator (4), is joined with the original radio frequency, and the radio signal is drawn to an intermediate frequency. The radio signal exiting said stirrer (3) and converted into the intermediate frequency is processed at an intermediate frequency end (5). The radio signal, reduced to the basic frequency band and filtered at said intermediate frequency end (5), is converted into digital signal by means of an analog-to-digital converter (6).

The radio receiver simultaneously receives the signal coming from pluralities of sources. For instance, while the radio receiver receives a target radio signal with −100 dBm power and 100 MHz center frequency coming from a far source, it receives at the same time an undesired signal with −10 dBm power and 120 Mhz center frequency. In order to reach the desired radio signal, the radio signal, received from the antenna (1), shall be transmitted to the intermediate frequency front end after eliminating the undesired signals. For this reason, sharp filters are used in the present art for eliminating the high powered and adjacent frequency undesired signals as in the example above. Since the dimensions of these filters are substantially big, they are not suitable for manually portable radio receivers.

In more details, the radio frequency front end (2) comprises a first amplifier (211) connected to the antenna (1). Said first amplifier (211) is a LNA (Low Noise Amplifier). Said first amplifier (211) has a limited gain. Said first amplifier (211) is connected to a first LC filter (221). Said first LC filter (221) comprises a first inductor bank (L1). Said first inductor bank (L1) is provided externally. The first inductor bank (L1) comprises pluralities of inductance elements connected to each other, and different inductance values are obtained by changing the configuration of said inductance elements. LC filter is a band-pass filter, and it is also known as LC tank in the related art.

The first LC filter (221) also comprises a first capacitor bank (C1). Said first capacitor bank (C1) is provided internally on the radio receiver chip. The first capacitor bank (C1) comprises pluralities of capacitors connected to each other. Different capacitance values are obtained by changing the configurations of the capacitors. Thus, the frequency range which passes through the first LC filter (221) can also be changed.

The first LC filter (221) also comprises a first variable resistor (R1). Thus, said first LC filter (221) has an adjustable quality factor value (known as Q-factor in the related art). The quality factor value shows how much the impedance decreases while diverging from the center frequency.

The first LC filter (221) is adjusted to the desired center frequency, and it provides a target signal, having this frequency, to be raised by the first amplifier (211), and it provides less rising or fixation of the undesired signals which are close to this frequency. At the same time, it prevents the undesired signals.

The radio frequency front end (2) also comprises a second amplifier (212) connected serially to the first amplifier (211). Said second amplifier (212) is connected to a second LC filter (222). Said second LC filter (222) comprises a second inductor bank (L2). In the preferred embodiment, said second inductor bank (L2) is externally provided. The second inductor bank (L2) comprises pluralities of inductance elements connected to each other, and the configuration of said inductance elements is also changed, and different inductance values are obtained. In the preferred embodiment, the LC filter is a band-pass filter and it is known as LC tank in the related art.

Moreover, the second LC filter (222) also comprises a second capacitor bank (C2). Said second capacitor bank (C2) is internally provided on the radio receiver chip. The second capacitor bank (C2) comprises pluralities of capacitors connected to each other. Different capacitance values are obtained by changing the configurations of the capacitors. Thus, the frequency range, passed by the second LC filter (222), can be changed.

Moreover, the second LC filter (222) comprises a second variable resistor (R2). Thus, said second LC filter (222) has an adjustable quality factor value.

The second LC filter (222) is adjusted to the desired center frequency, and this provides the target signal at this frequency to be raised by the second amplifier (212) and provides the undesired signals which are close to this frequency to be less amplified or to stay the same. After the first LC filter (221), filtering process is realized as a second step. The far undesired signals are prevented.

The radio frequency front end (2) comprises a first dampener (231) serially connected to the second amplifier (212) and also a third amplifier (213) serially connected to said first dampener (231). Said third amplifier (213) is connected to a third LC filter (223). Said third LC filter (223) comprises a third inductor bank (L3). Said third inductor bank (L3) is externally provided. The third inductor bank (L3) comprises pluralities of inductance elements connected to each other, and different inductance values are obtained by changing the configuration of said inductance elements.

The third LC filter (223) moreover comprises a third capacitor bank (C3). Said third capacitor bank (C3) is internally provided on the radio receiver chip. The third capacitor bank (C3) comprises pluralities of capacitors connected to each other. Different capacitance values are obtained by changing the configurations of the capacitors. Thus, the frequency range, passed by the first LC filter (221), can be changed.

The third LC filter (223) moreover comprises a third variable resistor (R3). Thus, said first LC filter (221) has an adjustable quality factor value.

The third LC filter (223) is adjusted to the desired center frequency, and it provides a target signal at this frequency to be raised by the first amplifier (211) and provides the undesired signals which are close to this frequency to be less raised or stay the same. The first LC filter (221), the second LC filter (222) and the third LC filter (223) provide filtering in a stepped manner.

The radio signal, whose frequency is changed by means of the local oscillator (4), is transmitted to the intermediate frequency end (5). The radio signal is afterwards passed through rising and filtering processes at the intermediate frequency end (5) and it is transmitted to an analog-to-digital converter, and here, it is converted into digital form.

A digital rear end (7) is provided in a connected manner to the radio frequency front end (2). Said digital rear end (7) changes the inner configuration of the first capacitor bank (C1) and the first inductor bank (L1) of the first LC filter (221) provided at the radio frequency front end, and it changes the frequency range passed by the first LC filter (221), and at the same time, it changes the first variable resistor (R1) and changes the quality factor. Thus, the first LC filter (221) is configured in a manner making the targeted frequency the center frequency. In a similar manner, the digital rear end (7) changes the second inductor bank (L2) of the second LC filter (222) and the inner configuration of the second capacitor bank (C2) and the value of the second variable resistor (R2). Again in a similar manner, the digital rear end (7) changes the third inductor bank (L3) of the third LC filter (223) and the inner configuration of the third capacitor bank (C3) and the value of the third variable resistor (R3). The ranges filtered by the first LC filter (221), the second LC filter (222) and the third LC filter (223) are changed, and radio signal sensing is provided at a widened range.

A second dampener (232) is serially connected to the third amplifier (213). Said digital rear end (7) changes the dampening coefficients of the first dampener (231) and the second dampener (232). Thus, when the desired signal is at a substantially high value, the radio signal can be dampened in order for the receiver not to be saturated.

Since the undesired signals which are very close to the desired signal after the first amplifier (211) and the second amplifier (212) are dampened less, the levels of said undesired signals are high, and they may affect the performance of the radio receiver. Therefore, the first dampener (231) and the second dampener (232) are used respectively before and after the third amplifier (213). Thus, the power of the signal is reduced before the third amplifier (213), and the third amplifier (213) is prevented from reaching saturation. In general, with respect to the signal envelope measurements to be made at the ends of the amplifiers and digital signal processing, maximum signal level is fixed at every point of the radio receiver, and the noise and linearity performances of the receiver will be simultaneously optimized.

In alternative embodiments, the element number of the chain formed by the abovementioned amplifier, filter and dampening elements can be increased. Thus, while the targeted signal is raised in the radio signal arriving at the stirrer, the close undesired signals are provided in the substantially same power, and the far signals are not provided since they are prevented.

In the preferred embodiment, the amplifiers (first amplifier (211), the second amplifier (212) and the third amplifier (213)) can focus in a range of 50 KHz at wavelength of 500 MHz.

The operation of a preferred embodiment of the radio receiver, whose details are given above, is as follows:

The radio signal is received by the antenna (1). When the desired signal has low power (for instance, −120 dBm power) and when the total of the signals provided in the radio signal is substantially low, the raising coefficients of the digital rear end (7) first amplifier (211), the second amplifier (212) and the third amplifier (213) are substantially increased. At the same time, the digital rear end (7) adjusts the center frequencies of the first LC filter (221), the second LC filter (222) and the third LC filter (223) to the center frequency of the desired signal. The first amplifier (211) and the first LC filter (221) raise the radio signal and filter the radio signal. In the first filtering, the far undesired signals are prevented, and this provides the desired signal to be raised, and provides the close undesired signals to be fixed or provides the close undesired signals to be less raised when compared with the desired signal. Thus, it becomes easier to reach the power levels of the desired signals and undesired signals and thus, it becomes easier to distinguish the signals and to filter at the intermediate frequency end (5).

After the radio signal is raised and filtered by means of the first amplifier (211) and first LC filter (221), the radio signal is raised and filtered by means of the second amplifier (212) and the second LC filter (222). Again in a similar manner, the far undesired frequencies are prevented, and the power of the desired signal is raised, and the power of the close desired signal is raised less than the rise of the desired signal frequency power. Again in a similar manner, raising and filtering process is realized by means of the third amplifier (213) and the third LC filter (223). Thus, while the power of the high powered close undesired signals stays substantially the same, the desired signal is raised. Thus, the elimination of the close undesired signal is facilitated by means of a filter when drawn to the basic band at the intermediate frequency end (5). At the radio frequency front end (2), instead of high Q and big dimensioned filters, integration to the chip can be provided by means of small dimensioned filters and stepped filtering such that the radio receiver can be manually carried.

In cases where the total power of the radio signal is high, in order to prevent overloading of the receiver, the digital rear end (7) increases the dampening coefficients of the first dampener (231) and the second dampener (232), and the radio signal is dampened. Additionally, in order to serve the same purpose, the rising coefficients of the first amplifier (211), the second amplifier (212) and the third amplifier (213) are decreased by the digital rear end (7).

The radio signal passing through stepped rising and stepped filtering processes arrives at the stirrer (3), and it is converted into a specific frequency by the local oscillator (4). Afterwards, it is reduced to basic band at the intermediate frequency end (5), and it is eliminated from undesired frequencies, and finally, it is converted into digital signal by the analog-to-digital converter (6). Thus, a dynamic range reaching 110 dBm can be obtained.

The protection scope of the present invention is set forth in the annexed Claims and cannot be restricted to the illustrative disclosures given above, under the detailed description. It is because a person skilled in the relevant art can obviously produce similar embodiments under the light of the foregoing disclosures, without departing from the main principles of the present invention.

1. A superheterodyne radio receiver comprising a radio frequency front end configured to process a radio signal, received by means of an antenna and including a desired signal, at the original frequency of the radio signal and which transmit the radio signal to a stirrer in order to be converted into digital signal, wherein said radio frequency front end comprises a first amplifier connected to the antenna and a first LC filter connected to said first amplifier,
said radio frequency front end comprises a second amplifier connected serially to said first amplifier in order to raise the radio signal in a stepped manner, and further comprises a second LC filter connected to said second amplifier in order to filter the radio signal in a stepped manner.

2. A radio receiver according to claim 1, wherein said first amplifier has an inlet which has substantially a broadband range and the output thereof is divided into pluralities of band ranges.

3. A radio receiver according to claim 1, wherein in order to raise the radio signal in a stepped manner, a third amplifier is provided which is connected to said second amplifier in a serial manner and a third LC filter is provided which is connected to said third amplifier in order to filter the radio signal in a stepped manner.

4. A radio receiver according to claim 3, wherein said radio frequency front end comprises a first dampener and a second dampener connected to each other and connected to the first amplifier, the second amplifier and the third amplifier in order to dampen the power of the radio signal in a stepped manner when the desired signal is at a substantially high power.

5. A radio receiver according to claim 4, wherein said first dampener is provided between the second amplifier and the third amplifier.

6. A radio receiver according to claim 4, wherein said second dampener is provided at the output of the third amplifier.

7. A radio receiver according to claim 1, wherein a digital rear end is provided which is connected to the radio frequency front end,
said digital rear end is configured in a manner changing the inner configuration of said first LC filter and said second LC filter and in a manner changing the band range which passes signal.

8. A radio receiver according to claim 3, wherein a digital rear end is provided which is connected to the radio frequency front end,
said digital rear end is configured in a manner changing the inner configuration of said first LC filter and said second LC filter and said third LC filter and in a manner adjusting the band range which passes signal.

9. A radio receiver according to claim 8, wherein said digital rear end is configured in a manner increasing the gain values of the first amplifier and the second amplifier when the power of the desired signal is substantially low.

10. A radio receiver according to claim 8, wherein said digital rear end is configured in a manner increasing the gain values of the first amplifier and the second amplifier when the power of the desired signal is substantially low,
said digital rear end is configured in a manner reducing the dampening coefficients of the first dampener and the second dampener.

11. A radio receiver according to claim 8, wherein said digital rear end is configured in a manner reducing the gain values of the first amplifier and the second amplifier when the power of the desired signal is substantially high.

12. A radio receiver according to claim 8, wherein said digital rear end is configured in a manner reducing the gain values of the first amplifier and the second amplifier when the power of the desired signal is substantially high,
said digital rear end is configured in a manner increasing the dampening coefficients of the first dampener and the second dampener.

13. A radio receiver according to claim 1, wherein said radio frequency front end comprises at least 4 LC filters.

14. A radio receiver according to claim 1, wherein said radio frequency front end comprises at least amplifiers.

15. A signal processing method at a radio frequency in order to process a radio signal, received by means of an antenna and including a desired signal, at the original frequency of the radio signal and transmitting said radio signal to a stirrer in order to be converted into digital signal, wherein the radio signal is raised and filtered by means of a first amplifier and a first LC filter adjusted in a substantially close manner to the center frequency of the desired signal,
the radio signal is raised and filtered by means of a second amplifier and a second LC filter adjusted in a substantially close manner to the center frequency of the desired signal.

16. A signal processing method at a radio frequency according to claim 15, wherein the radio signal is filtered and raised in a stepped manner by means of a third amplifier and by means of a third LC filter connected to said second amplifier.

17. A signal processing method at a radio frequency according to claim 15, wherein the radio signal is dampened in a stepped manner by means of a first dampener and a second dampener.

18. A signal processing method at a radio frequency according to claim 15, wherein the first LC filter, the second LC filter and the third LC filter change the inner configuration and change the band range which pass signal in accordance with the desired signal frequency.
